(19) United States
(12) Patent Application Publication
(10) Pub. No.: US 2010/0302207 A1
(43) Pub. Date: Dec. 2, 2010

(54) Optical Touch Control Method and Apparatus Thereof

(76) Inventor: Lan-Rong Dung, Hsinchu (TW)

Correspondence Address: STOUT, UXA, BUYAN & MULLINS LLP, 4 VENTURE, SUITE 300, IRVINE, CA, 92618, US

(21) Appl. No.: 12/473,183

(22) Filed: May 27, 2009

(51) Int. Cl. G06F 3/042

(52) U.S. Cl. 345/175

(57) ABSTRACT

An optical touch control method and apparatus are disclosed. The touch control method is used to provide a shadow from an object in accordance with a light source, and to determine the touch time and the touch location of the object in the display according to a width variance of the shadow. By utilizing the touch control method, the optical touch control apparatus can be implemented in large sized displays without substantial increases in cost.

### BACKGROUND OF THE INVENTION

1. Field of the Invention

The present invention relates to an optical touch device, and more particularly, to an optical touch control method and apparatus with a touch time that is determined according to a shadow of the object.

2. Description of the Prior Art

Touch apparatuses are becoming more and more general in application in most electronic devices, such as auto teller machines (ATMs) and so on. The utilization of touch control in many handheld devices, such as mobile phones and personal digital assistants, is now quite popular. Touch control technology mainly includes capacitive touch systems, resistor touch systems, optical touch systems, and so on. A driving method of the resistor touch system is to determine the coordinate axis in accordance with the voltage drop. When the resistor touchscreen is touched, a voltage drop occurs from activation of a corresponding circuit. The voltage drop is different when the touch location is different in the vertical and horizontal direction of the screen. Therefore, the controller is able to calculate the touched coordinate in accordance with the voltage drop. Capacitive touch systems use Indium Tin Oxide (ITO) glass as the transparent conductive structure. The driving method of the capacitive touch system is to discharge at four corners of the ITO glass whereby a uniform electric field is generated on the ITO glass. When a conductible object, such as a finger, touches the screen, the conductive object absorbs a small amount of conductive current. The capacitive touch can then calculate the percentage of conductive current lost to determine X axis and Y axis information for the touched coordinate.

Optical touch systems, on the other hand, have light source transmitters and receivers disposed in X axis and Y axis directions. The light source transmitters continually transmit infrared rays to form an array. When a finger, a pen, or any other object touches a point on the screen, light is blocked at that point. The system inputs corresponding data and determines X axis and Y axis information for the touched location.

However, as sizes and resolutions of touchscreen display devices increase, the mentioned touch control technologies are faced with commensurately greater demands for more touch detective elements. In other words, complexity and cost increase with the number of touch detective elements implemented in any given touchscreen. Therefore, it is necessary to design another kind of touch control technology for larger sized displays, without increasing cost, so as to achieve the purpose of accuracy of detection of the touched location in displays of relatively large size and resolution.

### SUMMARY OF THE INVENTION

A primary object of the present invention is to provide an optical touch control method to determine the touch location according to a shadow generated by an implement contacting or brought into close proximity with the touch location.

Another object of the present invention is to design an optical touch control method for utilization in a large size display device without using an unnecessarily large number of electrical conductors.

According to an aspect of the objects described above, an optical touch control method is disclosed herein. The optical touch control method includes the step of providing a shadow of an object by a first light source and the step of determining the touch location and the touch time of the object in a display.

In accordance with another aspect of the above objects, an optical touch control apparatus is disclosed herein, and the optical touch control apparatus includes a first light source and a detector. The detector determines the touch location and the touch time of an object according to the width variance of the shadow generated by the first light source.

### BRIEF DESCRIPTION OF THE DRAWINGS

The foregoing aspects and attendant advantages of this invention will become more readily appreciated as the same becomes better understood by reference to the following detailed description, when taken in conjunction with the accompanying drawings, wherein:

FIG. 1A and FIG. 1B are views illustrating a first embodiment of an optical touch control apparatus of the invention;

FIG. 2A and FIG. 2B are views illustrating a second embodiment of the optical touch control apparatus;

FIG. 3A, FIG. 3B, FIG. 3C and FIG. 3D are views illustrating relationships between a width of a shadow and time according to the present invention;

FIG. 4 is a flow chart illustrating an optical touch control method of the present invention;

FIG. 5 is a view illustrating a third embodiment of the present invention;

FIG. 6 is a view illustrating a fourth embodiment of the present invention; and

FIG. 7 is a view illustrating the optical touch control apparatus of the present invention implemented in a projector.

### DESCRIPTION OF THE PREFERRED EMBODIMENT

A detailed description of the present invention will be discussed in connection with the following embodiments, which are not intended to limit the scope of the present invention and which can be adapted for other applications. While the drawings are illustrated in detail, it is appreciated that the quantity of the disclosed components may be greater or less than that disclosed, except for instances expressly restricting the amount of the components.

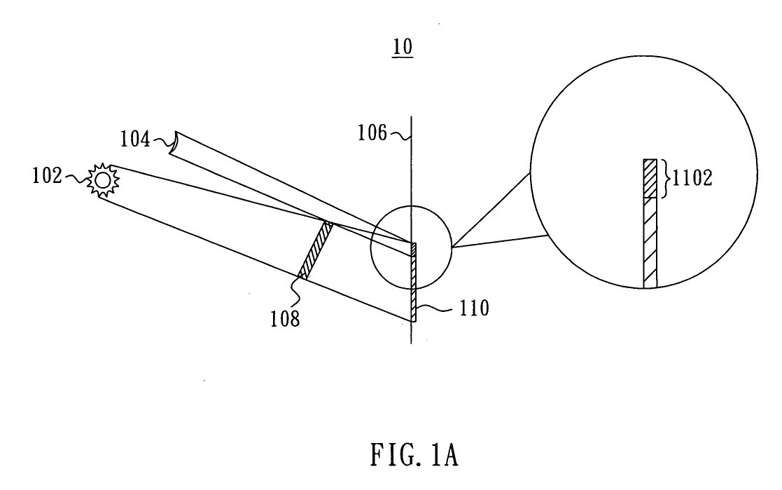

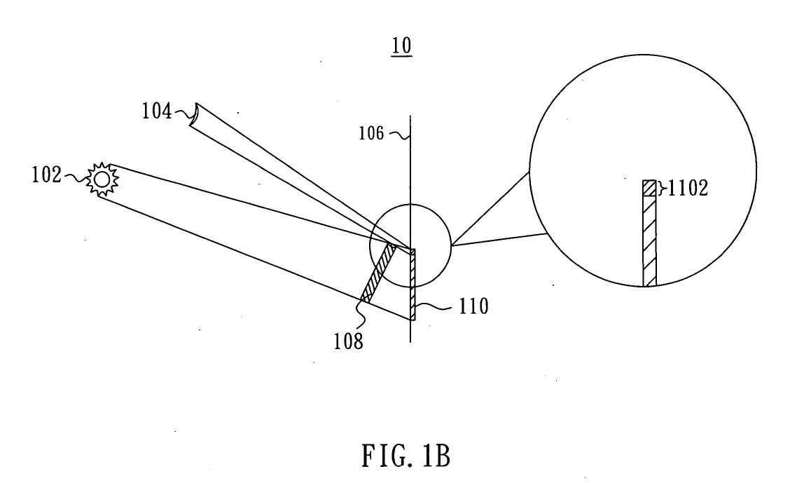

FIG. 1A and FIG. 1B are views illustrating a first embodiment of the optical touch control apparatus. As shown in FIG. 1A, the optical touch control apparatus 10 includes a first light source 102 and a detector 104. The first light source 102 can be a visible light source (such as a conventional light bulb) or a source for emitting invisible light (such as infrared rays). The first light source 102 emits light onto a display 106. However, in a different embodiment, the first light source 102 emits light onto a wall. The detector 104 (such as an image receiver) is used to detect a shadow 110 of an object 108 (such as a finger or a touch pen). When the shadow 110 appears on the display 106, the detector 104 determines whether the object 108 is touched on the display 106 according to the width variance of the visible shadow 1102. As the object 108 is moved close to the display 106, as shown in FIG. 1B, the visible shadow 1102 determined by the detector 104 becomes smaller. When the visible shadow 1102 vanishes or becomes invisible (the width of the visible shadow 1102 is equal to zero or close to zero), the detector 104 determines that the object has touched the display 106 so as to achieve a touch detection.

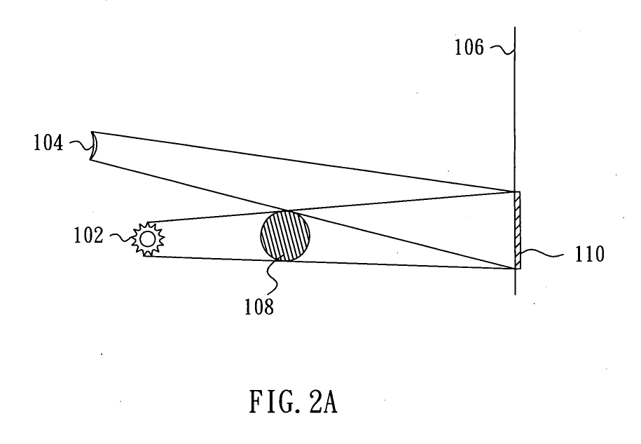

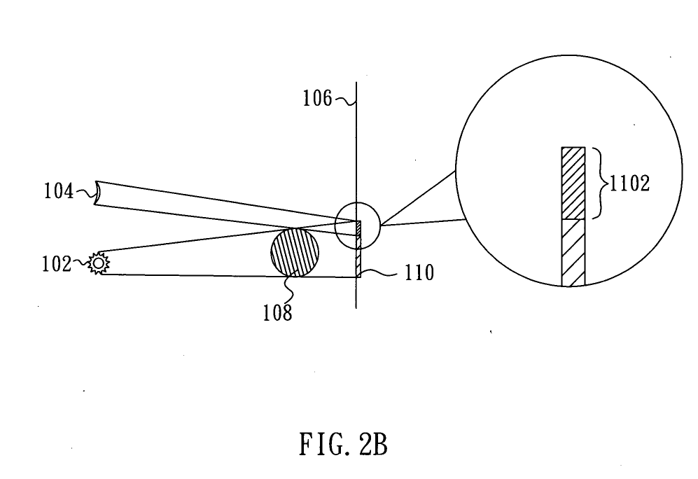

FIG. 2A and FIG. 2B are views illustrating a second embodiment of the optical touch control apparatus. As shown in FIG. 2A and FIG. 2B, the first light source 102 and the detector 104 are disposed in a different location of the optical touch control apparatus 10 according to a different environment. Comparing FIG. 1A and FIG. 1B, the locations of the first light source 102 and the detector 104 are lower than the locations in FIG. 1A and FIG. 1B. The detector 104 can be disposed in any location outside of the display 106 (the upper location or the lower location of the display) where the visible shadow 1102 of the object 108 is detectable so as to achieve the purpose of touch detection.

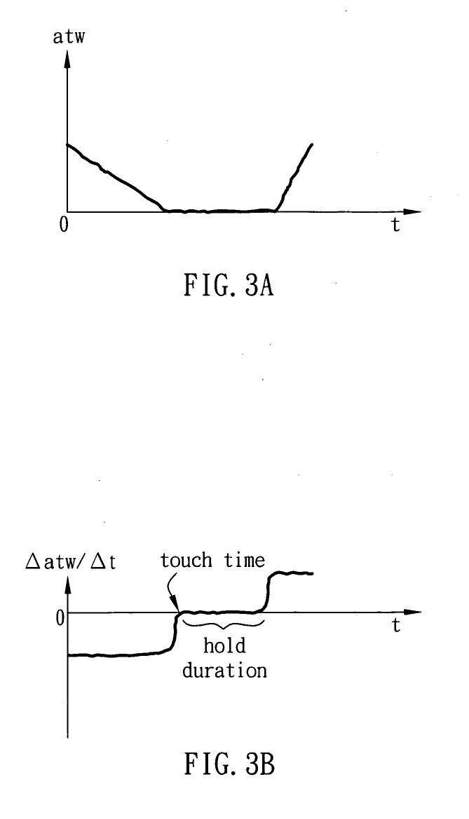

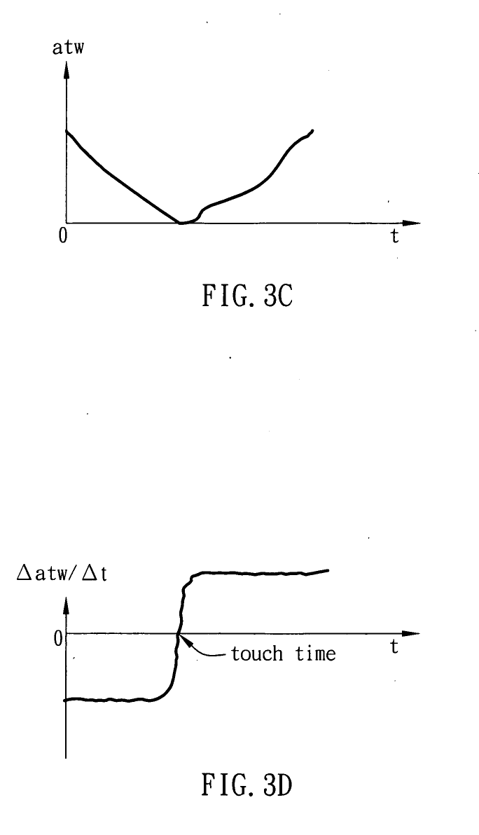

FIG. 3A, FIG. 3B, FIG. 3C and FIG. 3D are views illustrating relationships between the shadow width and time. As shown in FIG. 3A, as the object 108 is moved close to the display, the average tip width (ATW) of the shadow of the object becomes smaller. When the ATW is close to zero or equal to zero, the differential of the ATW for the time constant is equal to zero, and as shown in FIG. 3B, the moment for the touch to start is determined. When the ATW is increased from zero, the moment for the touch to be completed is determined. As shown in FIG. 3C, when the object is touched on and removed from the display in a very short time duration, such can also be determined by zero-crossing of the differential of the ATW, as shown in FIG. 3D. It should be noted that, in a different embodiment, the optical touch control apparatus of the present invention is able to be implemented in a multi-point touch operation. As the shadow variance in multi-point touching determined by the detector is easy to understand by those skilled in the art, a detailed description of such is omitted herein.

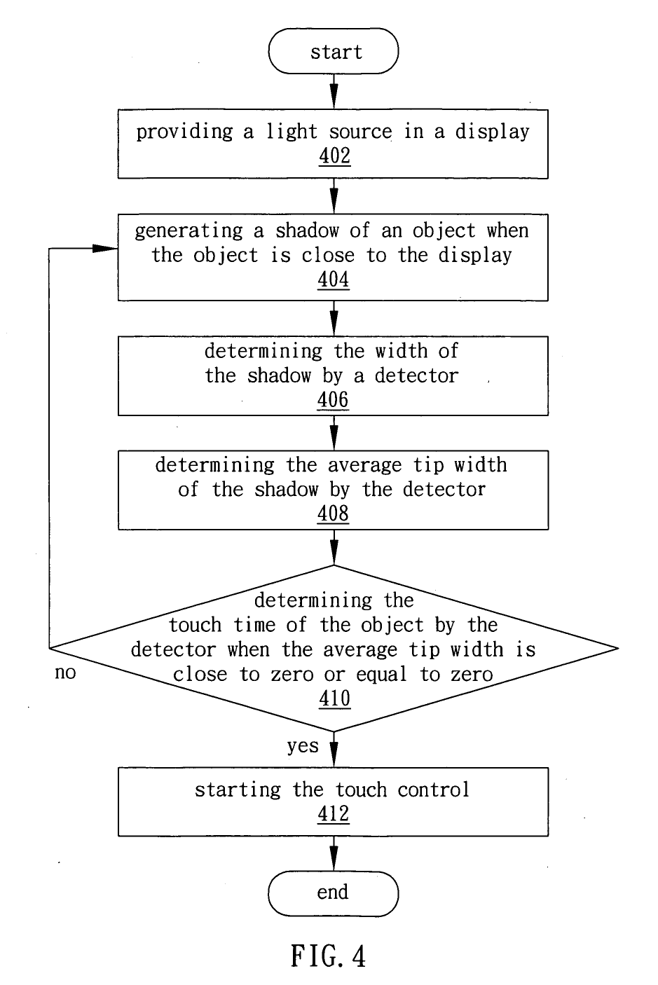

FIG. 4 is a flowchart illustrating the optical touch control method of the present invention. As shown in FIG. 4, in step 402, a light source is provided outside of the display. In step 404, as the object 108 is moved close to the display, the object generates a shadow on the display according to the light generated by the light source. In step 406, a detector is used to determine the width of the shadow. In step 408, the detector calculates the ATW of the shadow. In step 410, when the ATW of the shadow is close to zero or equal to zero, the time when the object is touched on the display is defined. Finally, in step 412, the touch control is started. The touch time can occur at any moment or during a period of time. In addition, the optical touch control method is not only applicable for single-point touching, but the optical touch control method of the present invention is also able to be used in multi-point touching applications, so long as the device based on the present invention is configured to detect multiple shadows, as will be apparent to those skilled in the art in view of this disclosure.

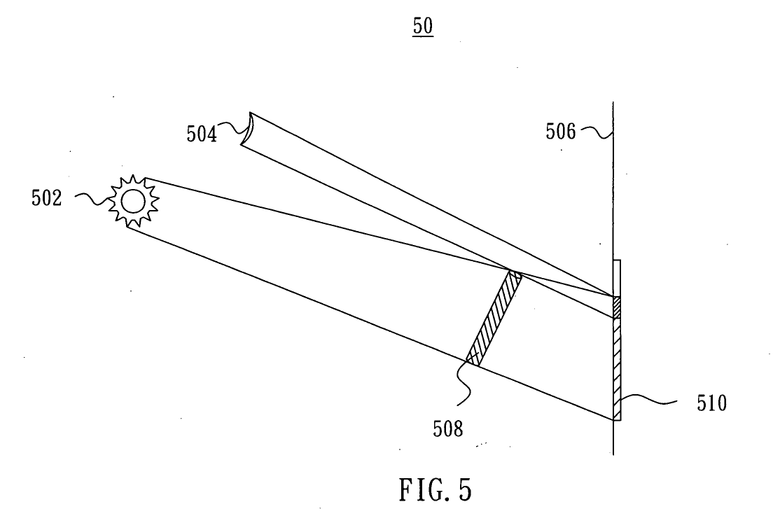

FIG. 5 is a view illustrating a third embodiment of the present invention. Because the optical touch control apparatus of the present invention operates to determine the touch point in accordance with the shadow of the touch object, it is not necessary to use a relatively large number of electrical conductors (e.g., wires) in the apparatus. According to the advantage described above, a virtual switch is designed by utilizing the optical touch control apparatus. As shown in FIG. 5, the virtual switch 50 includes a first light source 502 and a detector 504. The first light source 502 will provide light for producing a shadow and can additionally project an image (such as a switching device image), when required, on the wall 506 (or display). The detector 504 is used to detect the width variance of the shadow 510 of a finger 508 (or any other object) at a fixed location or a fixed image. When a user wishes to turn on/off the virtual switch 50, the user's finger 508 points to the fixed location or the fixed image. When the finger 508 touches the fixed location or fixed image and the detector 504 detects that the width of the shadow 510 is close to zero or equal to zero, the detector 504 determines the occurrence of a touch time. Therefore, the information of the touch time is transmitted to electric equipment or an electronic device so as to turn on or turn off the electric equipment or the electronic device. According to the design described above, because there are no electrical wires connected between the virtual switch and the electronic device, it is not necessary to dispose the virtual switch in a fixed location as is the case for a conventional switch. Moreover, the user can move the first light source 502 and the detector 504 to a different location, whereby the electronic device can also be turned on or turned off.

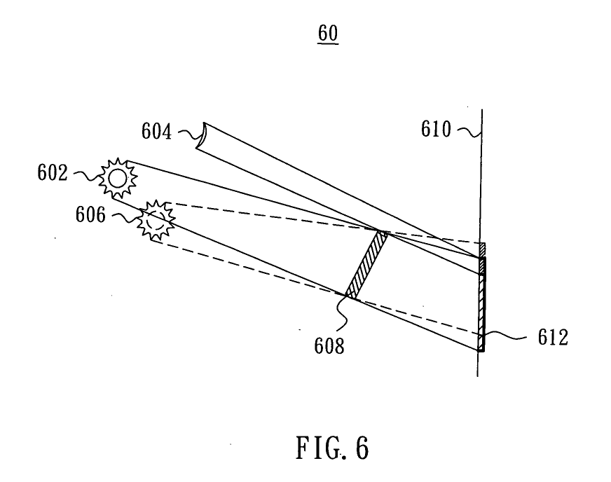

FIG. 6 is a fourth embodiment of the optical touch control apparatus of the present invention. As shown in FIG. 6, the optical touch control apparatus 60 includes a first light source 602, a detector 604, and a second light source 606. In comparison to the embodiments of the optical touch control apparatus in the previous drawing, the optical touch control apparatus 60 of the present embodiment further includes a second light source 606. Because the optical touch control apparatus 60 of the present invention operates to implement the width variance of the shadow of an object 608 projected on the display to determine the touch location of the touch time, the luminance of external light (such as solar light or light from any other light source) can be bright enough to affect the accuracy of the detection of the optical touch control apparatus 60. Therefore, the optical touch control apparatus 60 can further include the second light source 606, and the second light source 606 can also be a visible light source (such as a conventional light bulb) or a source for emitting invisible light (such as infrared rays). The purpose of the installation of the second light source 606 is to strengthen the display of the shadow 612 of the object 608 so as to enhance the accuracy of detection by the detector 604. Because the operation of the optical touch control apparatus 60 in FIG. 6 is the same as that of the embodiments in the previous drawings, a detailed description of the optical touch control apparatus 60 is omitted herein.

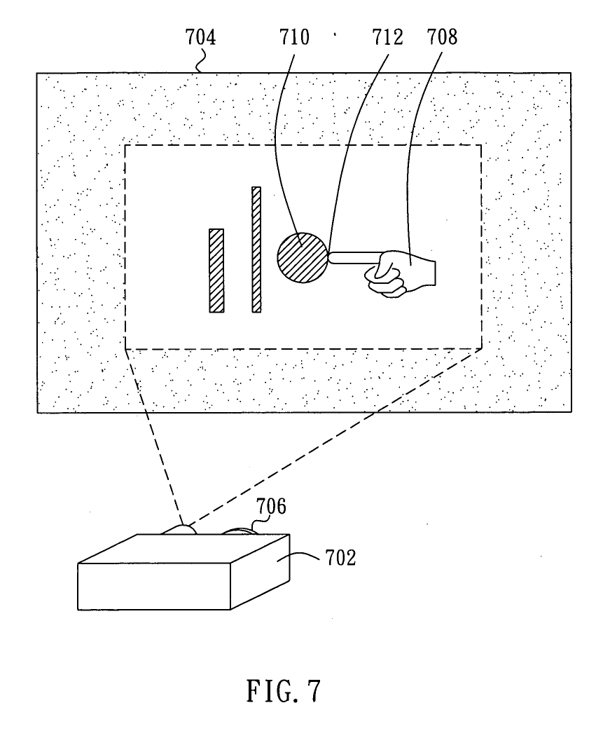

Moreover, it should be noted that the optical touch control method of the present invention is also able to be implemented in a projector, as shown in FIG. 7. The projector 702 projects the image on a screen 704 (or wall), and the detector 706 is disposed at a location near the projector 702. When a finger 708 (or a touch pen or other implement) of a user produces a shadow 710 on the screen 704, the touch point is detected. Therefore, when the size of the display screen is increased, the optical touch control apparatus of the present invention does not need to add additional electronic elements that would increase the cost.

Although specific embodiments have been illustrated and described, it will be appreciated by those skilled in the art that various modifications may be made without departing from the scope of the present invention, which is intended to be limited solely by the appended claims.

What is claimed is:

1. An optical touch control method, comprising:
providing a shadow of an object by a first light source; and
determining a touch location and a touch time of said object in a display.

2. The optical touch control method according to claim 1, wherein said method further includes determining said touch location and said touch time of said object in said display according to a detector used to determine the width variance of said shadow.

3. The optical touch control method according to claim 2, wherein said detector is an image receiver.

4. The optical touch control method according to claim 1, wherein said method further includes providing a second light source to strengthen said shadow of said object so as to enhance the accuracy of said optical touch control method.

5. The optical touch control method according to claim 4, wherein said second light source emits invisible light.

6. The optical touch control method according to claim 1, wherein said optical touch control method is implemented in multi-point touching.

7. The optical touch control method according to claim 1, wherein said display is a projector.

8. The optical touch control method according to claim 1, wherein said first light source emits invisible light.

9. An optical touch control method, comprising:
providing a first light source in a display;
generating a shadow of an object in said display when said object is moved close to said display;
determining a width variance of said shadow by a detector; and
determining a touch time of said object by said detector, when the width of said shadow is close to or equal to zero.

10. The optical touch control method according to claim 9, wherein said method further includes providing a second light source to strengthen said shadow of said object so as to enhance the accuracy of said optical touch control method.

11. The optical touch control method according to claim 10, wherein said second light source emits invisible light.

12. The optical touch control method according to claim 10, wherein said display is a projector.

13. An optical touch control apparatus, comprising:
a first light source; and
a detector, said detector being configured to determine a touch location and a touch time of an object according to a width variance of a shadow generated by said first light source.

14. The optical touch control apparatus according to claim 13, wherein said detector is an image receiver.

15. The optical touch control apparatus according to claim 13, wherein said apparatus further includes a second light source used to strengthen said shadow of said object so as to enhance the accuracy of said optical touch control apparatus.

16. The optical touch control apparatus according to claim 15, wherein said second light source is structured to emit invisible light.

17. The optical touch control apparatus according to claim 13, wherein said optical touch control apparatus is a multi-point optical touch control apparatus.

18. The optical touch control apparatus according to claim 13, wherein said display is a projector.

19. The optical touch control apparatus according to claim 13, wherein said first light source is configured to emit invisible light.

20. The optical touch control apparatus according to claim 13, wherein said optical touch control apparatus is implemented in a switching device.
